(19) United States
(12) Patent Application Publication
(10) Pub. No.: US 2010/0235752 A1
(43) Pub. Date: Sep. 16, 2010

(54) BUSINESS SUPPORT SYSTEM AND BUSINESS SUPPORT APPARATUS

(75) Inventor: Yoshiko SHIIMORI, Ashigarakami-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/709,723

(22) Filed: Feb. 22, 2010

(30) Foreign Application Priority Data
Mar. 16, 2009 (JP) JP2009-063053

(51) Int. Cl. G06F 17/30; G06F 3/048; G06F 15/16

(52) U.S. Cl. 715/738; 707/812; 707/E17.009

(57) ABSTRACT

A business support system includes: a portable terminal used by a user; and a business support apparatus connected with the portable terminal, the portable terminal including: an input device; a device for accepting an input into the input device; a device for transmitting a signal indicating that the input is accepted to the business support apparatus; a device for receiving a page transmitted from the business support apparatus; a display device; and a device for causing the display device to display the received page, and the business support apparatus including: a device for receiving a transmitted signal; a database for storing information about the user or information about a customer of the user; a device for generating a page suitable for the user based on the information in the database when receiving the signal; and a device for transmitting the generated page to the portable terminal.

### BACKGROUND OF THE INVENTION

1. Field of the Invention

The presently disclosed subject matter relates to a business support system and a business support apparatus, and particularly relates to a business support system and a business support apparatus utilizing a portable terminal.

2. Description of the Related Art

Systems for supporting business by using a portable telephone while away from office are becoming widely available, in which various services such as mail transmission/reception, document browsing, schedule management, and inventory management are provided.

Japanese Patent Application Laid-Open No. 2004-258824 describes a service mediation method and device for receiving the provision of services by use of a PC (personal computer), a PDA (personal digital assistant), a portable telephone, etc. The service mediation method and device, when detecting a service request from a service using terminal, collects necessary data depending on the detected service request, and generates appropriate output data.

### SUMMARY OF THE INVENTION

However, in Japanese Patent Application Laid-Open No. 2004-258824, the operability of the portable telephone is not taken into consideration. When using a service using a narrow screen and cursor functionalities of a portable telephone, as the number of functions concerning the service increases, it becomes more difficult for a user of the service to find a function which the user wishes to use. Also, as the number of functions concerning the service increases, the manipulation to reach such a function includes more steps thereby significantly impairing operability.

As the method of improving the operability of a portable telephone, assigning functions to ten-key key pads of the portable telephone is commonly practiced. However, as the number of functions increases, a user has difficulty in remembering which function is assigned to which key pad and, thus, the system becomes unable to achieve expected effects.

The presently disclosed subject matter has been made in view of the above described circumstances, and an object of the presently disclosed subject matter is to provide a business support system and business support apparatus which enables a user to receive a service that transmits a page suitable for the user to a portable equipment of the user, just by pressing a button of the portable equipment.

A first aspect of the presently disclosed subject matter provides a business support system including: a portable terminal used by a user; and a business support apparatus connected with the portable terminal, wherein the portable terminal includes: an input device; an acceptance device for accepting an input into the input device; a first transmission device for transmitting a signal indicating that the input is accepted, to the business support apparatus when the acceptance device accepts the input; a first reception device for receiving a page transmitted from the business support apparatus; a display device; and a display control device for causing the display device to display the page received by the first reception device, and wherein the business support apparatus includes: a second reception device for receiving a signal transmitted by the first transmission device; a database for storing information about the user or information about a customer of the user; a page generation device for generating a page suitable for the user based on the information stored in the database, upon reception of the signal from the reception device; and a second transmission device for transmitting the page generated by the page generation device to the portable terminal.

According to the business support system set forth in the first aspect, upon acceptance of the input into the input device of the portable terminal, a signal indicating the acceptance of the input is transmitted from the portable terminal to the business support apparatus; and upon receiving the signal, the business support apparatus generates a page suitable for the user based on the information stored in a database and transmits the generated page to the portable terminal. As a result of this, it becomes possible to provide a service which, upon a touch of a button by a user, transmits a page suitable for the user to the portable equipment.

A second aspect of the presently disclosed subject matter provides the business support system according to the first aspect, wherein: the portable terminal includes a position information acquisition device for acquiring position information of the portable terminal, the database stores position information of the customer as information about the customer of the user, the first transmission device transmits the position information acquired by the position information acquisition device to the business support apparatus, the second reception device acquires the position information transmitted from the first transmission device, and the page generation device identifies a customer of a visiting destination of the user based on the position information acquired by the second reception device and the position information of the customer stored in the database, and generates a page about the identified customer.

According to the business support system set forth in the second aspect, the position information of the portable terminal is acquired, and a customer of a visiting destination of the user is identified based on the acquired position information and the position information of customers stored in a database so that a page about the identified customer is generated. As a result of this, the user can automatically receive the provision of a page about the customer whom he or she is going to visit.

A third aspect of the presently disclosed subject matter provides the business support system according to the first or second aspect, wherein: the business support apparatus includes a time information acquisition device for acquiring a current time, the database stores a schedule of the user as the information about the user, and the page generation device generates a page in accordance with a current schedule of the user based on the current time acquired by the time information acquisition device and the schedule stored in the database.

According to the business support system set forth in the third aspect, a page in accordance with a current schedule of a user is generated based on a current time and schedule. As a result of this, the user can automatically receive the provision of a page in accordance with a schedule of the user.

A fourth aspect of the presently disclosed subject matter provides the business support system according to the third aspect, wherein: the database stores a visiting time, a customer of a visiting destination, and a visiting purpose in association with each other as the schedule of the user, and the page generation device generates a page in accordance with the customer of the visiting destination and the visiting purpose of the user.

According to the business support system set forth in the fourth aspect, a page in accordance with the current schedule of a user is generated based on a schedule in which a current time, visiting time, customer of the visiting destination, and visiting purpose are associated with each other. Accordingly, it possible to provide the user with a page which is desired by the user more precisely.

A fifth aspect of the presently disclosed subject matter provides the business support system according to any one of the first to fourth aspects, wherein: the database stores a history of pages transmitted to the portable terminal, and the page generation device generates a page based on the history stored in the database.

According to the business support system set forth in the fifth aspect, a page is generated based on a history of pages which are transmitted to the portable terminal. As a result of this, the user can receive the provision of a page which the user often browses.

A sixth aspect of the presently disclosed subject matter provides the business support system according to the fifth aspect, wherein: the business support apparatus includes a time information acquisition device for acquiring a current time, the database stores a transmitted page and a transmission time in association with each other, and the page generation device generates a page included in a category of pages which is most often transmitted in a predetermined time period including the current time based on the current time acquired by the time information acquisition device.

According to the business support system set forth in the sixth aspect, a page included in the category of pages which is most frequently transmitted within a predetermined time period including the current time is generated based on the information which stores a transmitted page and a transmission time in association with each other. As a result of this, a user can receive the provision of a page which the user most often browses.

A seventh aspect of the presently disclosed subject matter provides the business support system according to the fifth or sixth aspect, wherein: the portable terminal includes a position information acquisition device for acquiring position information of the portable terminal, the database stores a transmitted page and a position at which the transmitted page is received by the portable terminal in association with each other, the first transmission device transmits the position information acquired by the position information acquisition device to the business support apparatus, the second reception device acquires the position information transmitted from the first transmission device, and the page generation device generates a page included in a category of pages which is most often received within a predetermined range including the acquired position of the portable terminal, based on the position information of the portable terminal acquired by the second reception device.

According to the business support system set forth in the seventh aspect, the position information of the portable terminal is acquired and a page included in the category of pages which is most often transmitted within a predetermined range including the position of the portable terminal is generated. As a result of this, a user can receive the provision of a page which the user most often browses.

An eighth aspect of the presently disclosed subject matter provides the business support system according to any one of the first to seventh aspects, wherein: the portable terminal includes a plurality of input buttons, the acceptance device judges to which input button of the plurality of buttons an input is accepted, the first transmission device transmits a judgment result by the acceptance device, the database stores an assignment of service for each input button of the plurality of input buttons, and the page generation device generates a page in accordance with the service assigned to the input button which has accepted the input based on the judgment result by the reception device and the assignment of service for each input button stored in the database.

A ninth aspect of the presently disclosed subject matter provides a business support apparatus included in the business support system according to any one of the first to eighth aspects.

According to the presently disclosed subject matter, a user can receive a service that transmits a page suitable for the user to a portable equipment of the user, just by pressing a button of the portable equipment.

### BRIEF DESCRIPTION OF THE DRAWINGS

FIG. 1 is a block diagram illustrating a business support system 1 according to a first embodiment of the presently disclosed subject matter;

FIG. 2 is an outline view of a client portable terminal 20 included in the business support system 1;

FIG. 3 illustrates an example of user information stored in a storage device 11d;

FIG. 4 illustrates an example of customer information stored in the storage device 11d;

FIG. 5 illustrates an example of customer position information stored in the storage device 11d;

FIG. 6 illustrates an example of schedule information stored in the storage device 11d;

FIG. 7 illustrates an example of access history information stored in the storage device 11d;

FIG. 8 illustrates an example of service information stored in the storage device 11d;

FIG. 9 illustrates an example of service information stored in the storage device 11d;

FIG. 10 illustrates an example of service assignment information stored in the storage device 11d;

FIG. 11 illustrates an example of sales by customer information stored in the storage device 11d;

FIG. 12 illustrates an example of inventory status by customer information stored in the storage device 11d;

FIG. 13 illustrates an example of provided service history information stored in the storage device 11d;

FIGS. 14A and 14B are flowcharts illustrating the flow of the process of a business support apparatus 10 of the business support system 1; and

FIG. 15 illustrates an example of a page displayed on a client portable terminal 20.

### DETAILED DESCRIPTION OF THE PREFERRED EMBODIMENTS

### First Embodiment

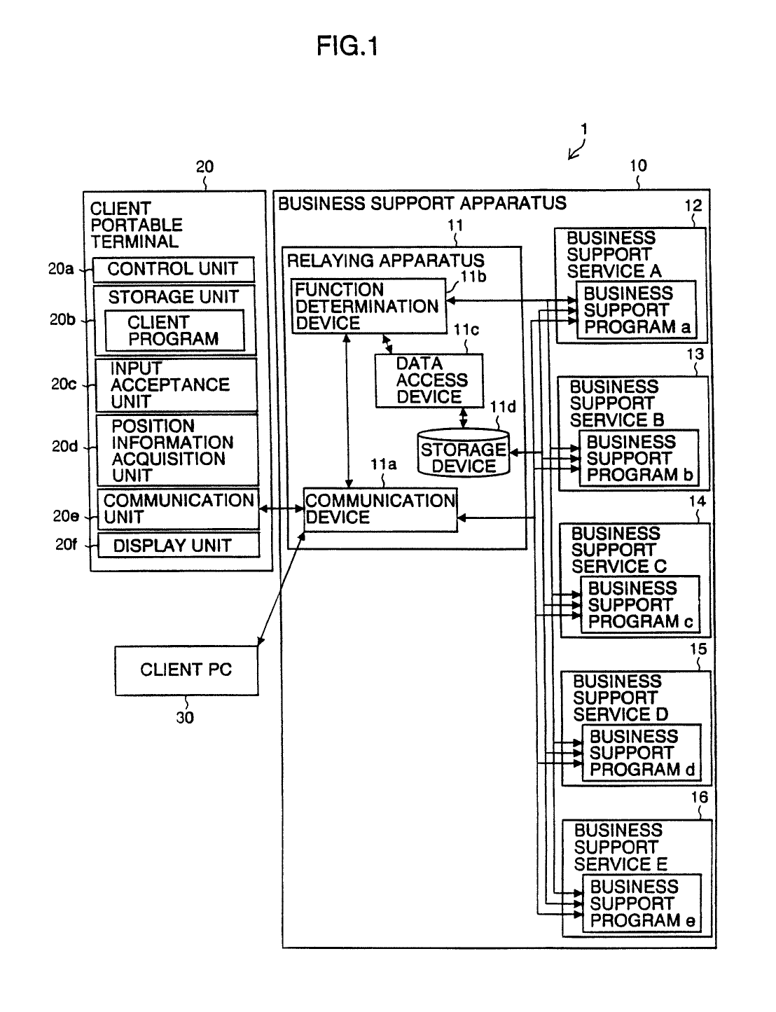

FIG. 1 is a block diagram illustrating a business support system 1 according to a first embodiment. The business support system 1 includes a business support apparatus 10, a client portable terminal 20, and a client PC (personal computer) 30. In FIG. 1, the business support system 1 includes only one client portable terminal 20 as the terminal for client. However, the business support system 1 may include a plurality of client portable terminals 20. Further, the business support system 1 may not include the client PC 30 and may include only the business support apparatus 10 and the client portable terminal 20.

First, the client portable terminal 20 will be described. The client portable terminal 20 is, for example, a portable telephone and is connected with the business support apparatus 10 via a network.

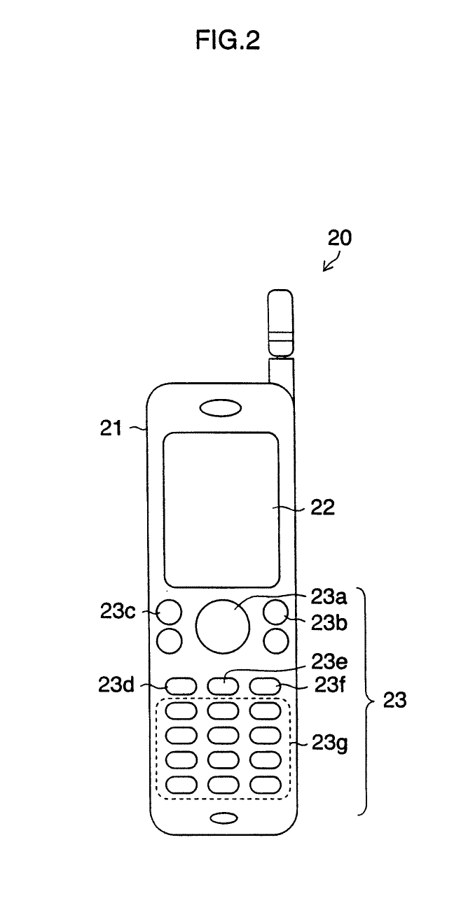

As illustrated in FIG. 2, the client portable terminal 20 includes a terminal main body 21, a display unit 22, and an operation unit 23.

The display unit 22 is a liquid crystal display capable of color display, and is provided in the front surface of the terminal main body 21. The display unit 22 is not limited to a liquid crystal display, and those of organic EL (electroluminescent), etc. may be used.

The operation unit 23 includes a cross-key 23a, a “button A” 23b, a “button B” 23c, a “major button A” 23d, a “major button B” 23e, a “major button C” 23f, and a ten-key 23g.

The cross-key 23a is a button for moving a cursor vertically and horizontally and for scrolling the screen vertically.

The “button A” 23b is a button to move the screen forward and the “button B” 23c is a button to move the screen backward by one step.

The “major button A” 23d, the “major button B” 23e, and the “major button C” 23f are buttons for receiving services by the business support apparatus 10. Different services are assigned to the “major button A” 23d, the “major button B” 23e, and the “major button C” 23f respectively by the user, and the information about the services assigned to each major button is stored in a storage device 11d (to be described later in detail).

The ten-key 23g is buttons for performing the input of numerals, characters (kanji-characters, alphanumeric characters), etc.

Next, the electric configuration inside the client portable terminal 20 will be described. Note that, known functions such as the call function and mail function of the client portable terminal 20 will be omitted from illustration and description.

As shown in FIG. 1, the client portable terminal 20 includes a control unit 20a, a storage unit 20b, an input acceptance unit 20c, a position information acquisition unit 20d, a communication unit 20e, and a display unit 20f.

The control unit 20a integrally controls the client portable terminal 20 as a whole according to a predetermined control program and a client program for receiving business support services. Moreover, the control unit 20a includes a memory area to be used as an operations work area of the control unit 20a.

The storage unit 20b stores the control program and various data which are needed for control etc. Further, the storage unit 20b includes a storage area dedicated for a client program, in which the client program is stored in advance.

The input acceptance unit 20c detects an input into the operation unit 23 and determines to which button the input is performed. Then, the input acceptance unit 20c outputs the determination result to the control unit 20a, the communication unit 20e, and the like.

The position information acquisition unit 20d uses the GPS (Global Positioning System) and receives radio waves from a plurality of GPS satellites to acquire an position information of the client portable terminal 20. The position information acquisition unit 20d outputs the acquired position information to the communication unit 20e. Although the position information acquisition unit 20d uses the GPS to acquire the position information of the client portable terminal 20, the method for acquiring position information is not limited this. For example, the range identified from the position of the local station which communicates with the client portable terminal 20 may be acquired as the position information.

The communication unit 20e transmits the determination result outputted from the input acceptance unit 20c and the position information outputted from the position information acquisition unit 20d to the business support apparatus 10. Moreover, the communication unit 20e receives a page (to be described later in detail) transmitted from the business support apparatus 10.

The display unit 20f includes, for example, a liquid crystal display capable of color display. The display unit 20f is configured to display a page (to be described later in detail) transmitted from the business support apparatus 10, and is used as display panel for a user interface (GUI: graphical user interface) for performing various setting operations.

The client PC 30 is, for example, a personal computer (PC), and is connected with the business support apparatus 10 via network. The client PC 30 performs the updating of the information stored in the storage device 11d and the like. The configuration and function of the client PC 30 are already publicly known and therefore description thereof will be omitted.

Next, details of the business support apparatus 10 will be described. The business support apparatus 10 includes a relaying apparatus 11, a “business support service A” 12, a “business support service B” 13, a “business support service C” 14, a “business support service D” 15, and a “business support service E” 16.

The relaying apparatus 11 includes a communication device 11a, a function determination device 11b, a data access device 11c, and a storage device 11d.

The communication device 11a receives the judgment result transmitted from the client portable terminal 20. Moreover, the communication unit 20e transmits a page generated in the “business support service A” 12 (to be described later in detail) and the like to the client portable terminal 20.

The function determination device 11b determines what kind of page is to be generated based on the judgment result received by the communication device 11a. The function determination device 11b outputs the judgment result to the data access device 11c. Further, the function determination device 11b issues, based on the judgment result, an instruction, which requires to generate a page, to any of the “business support service A” 12, the “business support service B” 13, the “business support service C” 14, the “business support service D” 15, and the “business support service E” 16.

The data access device 11c acquires necessary data from the storage device 11d based on the determination result outputted from the function determination device 11b and outputs it to the function determination device 11b.

The storage device 11d stores user information, customer information, customer address information, schedule information, access history information, service information, service assignment information, sales by customer information, inventory status by customer, and provided service history information, etc.

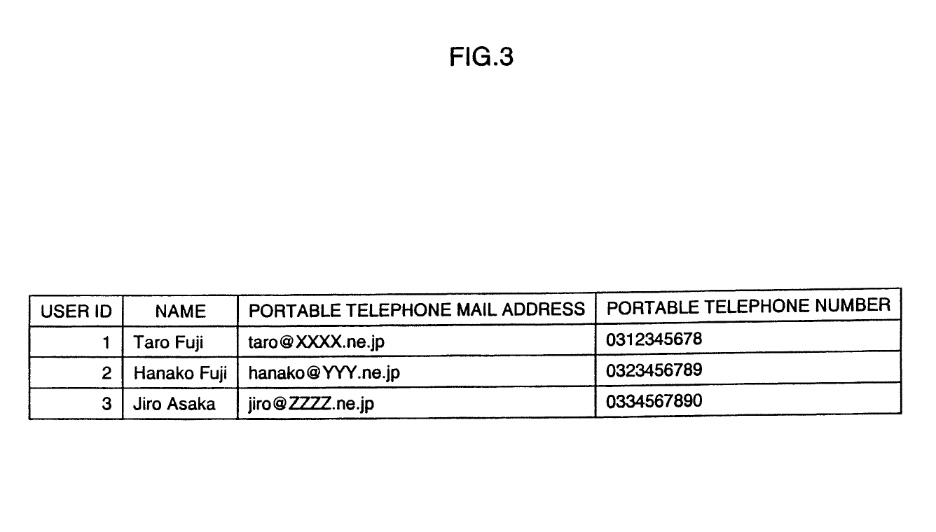

The user information stores information about users such as user names, and telephone numbers. The stored user information includes, for example as illustrated in FIG. 3, user IDs of each user, user names, and portable telephone mail addresses in association with one another. The user information is updated via the client PC 30 etc. such as when a new user (client portable terminal) is added.

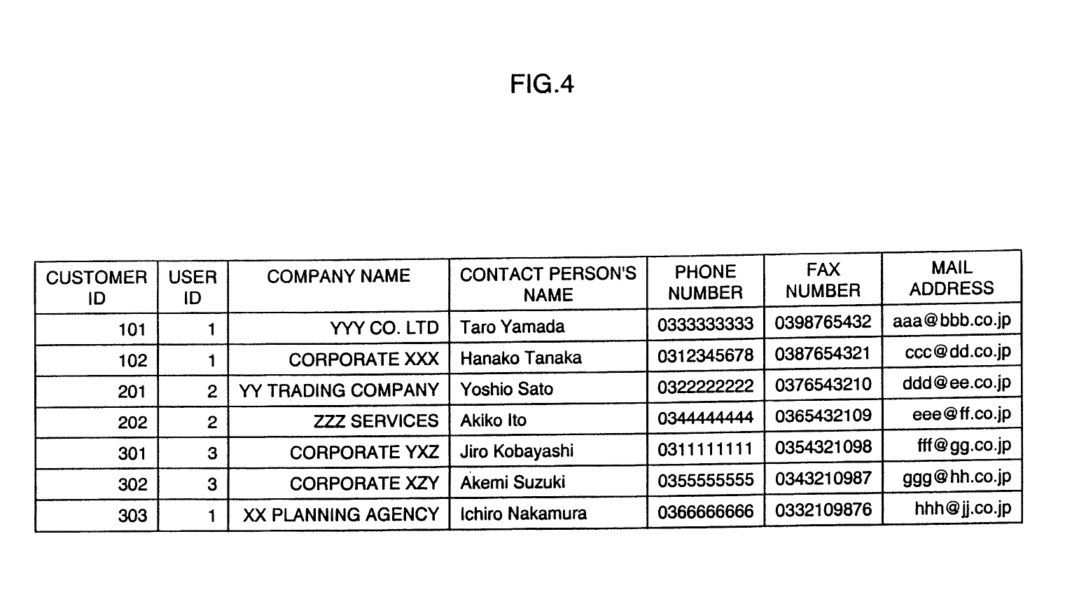

The customer information includes information about customers such as customer names and telephone numbers. The stored customer information includes, for example as illustrated in FIG. 4, customer IDs of each customer; information about customers such as company names, telephone numbers, FAX (facsimile) numbers, and mail addresses; and information about contact persons of the customers (user ID and user name), in association with one another. The customer information is updated via the client PC 30 etc. such as when a new customer is added. Note that although in FIG. 4, user IDs and names are stored in the information about contact persons of customer, only user IDs may be sufficient.

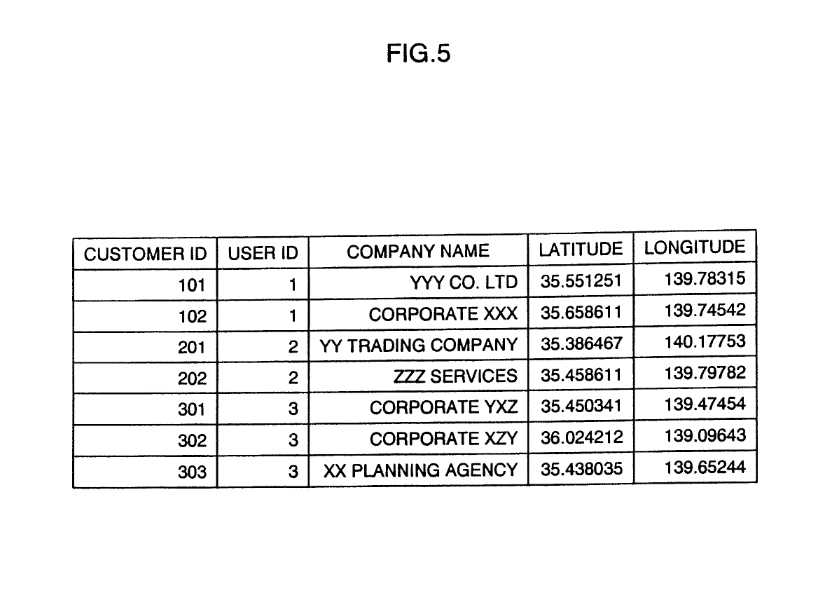

The customer address information stores information indicating the address of customer. The stored customer address information includes, for example as illustrated in FIG. 5, customer IDs, company names, and position information represented by latitudes and longitudes in association with one another. The customer address information is updated via the client PC 30 etc. at the same time with the updating of the customer information. Note that although the IDs of customers and company names are stored in FIG. 5, customer IDs alone are also sufficient. Moreover, although the customer address information illustrated in FIG. 5 includes, for the convenience sake, customer IDs and user IDs of contact persons in association with each other, this is not a necessity.

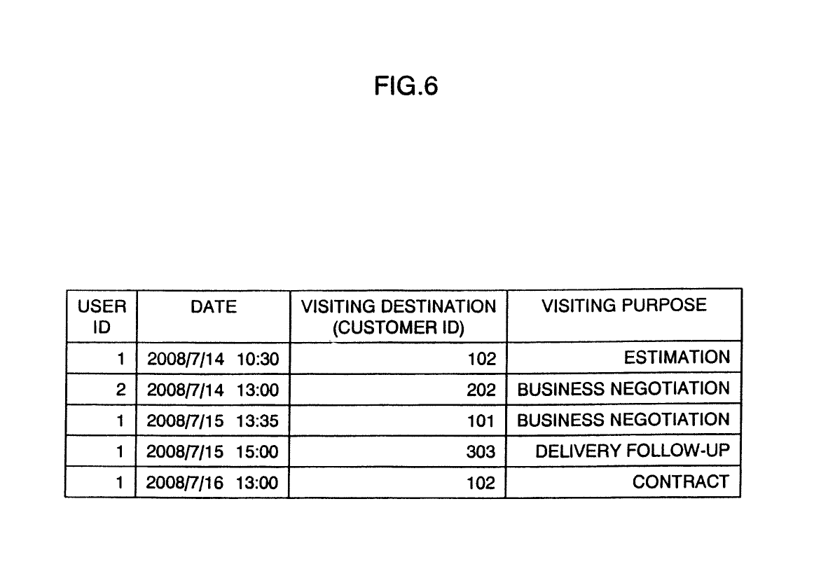

The schedule information includes the schedule of user. The schedule information includes, for example as illustrated in FIG. 6, user IDs, dates of registered schedules, customer IDs, and visiting purpose information representing the purpose for which the user visits the customer, in association with one another. The schedule information is automatically updated, for example, as the result of a schedule being transmitted from the client portable terminal 20 to the business support apparatus 10.

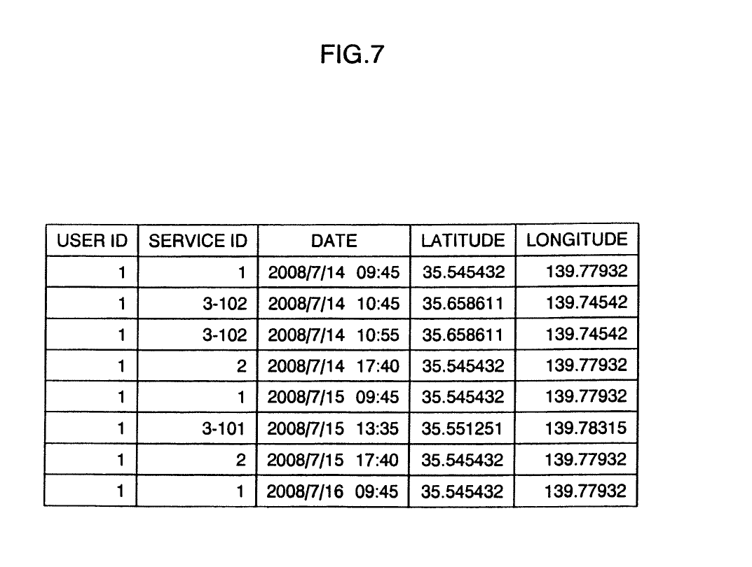

The access history information includes information about when and where, and which service the user has used, for each user. The access history information includes, as illustrated in FIG. 7, user IDs, service IDs (to be describe later in detail), dates when a service is used, and position information (a latitude and longitude) where a service is used, in association with one another. The updating of the access history will be described later in detail.

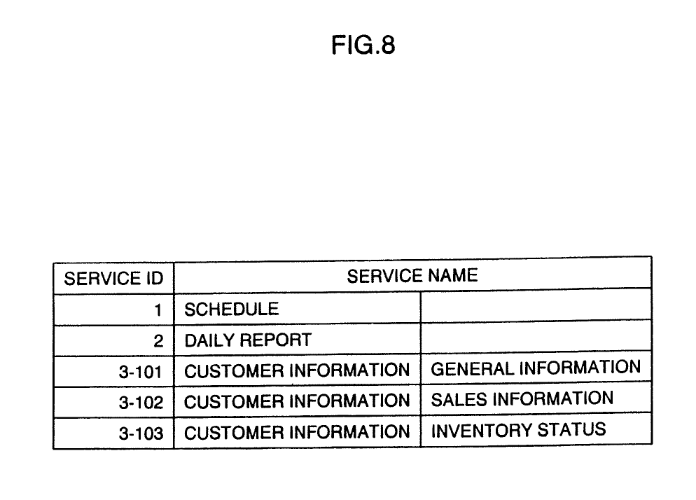

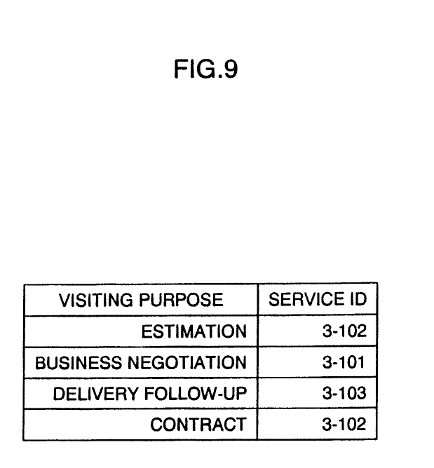

The service information includes information by which the function determination device 11b determines which service to provide (what kind of page needs to be generated). The service information includes, for example as illustrated in FIG. 8, service IDs of each service and service names which are information to indicate which kind of page needs to be generated, in association with each other. Further, the service information includes, for example as illustrated in FIG. 9, visiting purpose information illustrated in FIG. 6 and service IDs of the services which are expected to be requested by the user based on the visiting purpose information, in association with each other. As the service information, those stored in advance in the storage device 11d as an initial setting is used and may not be updated.

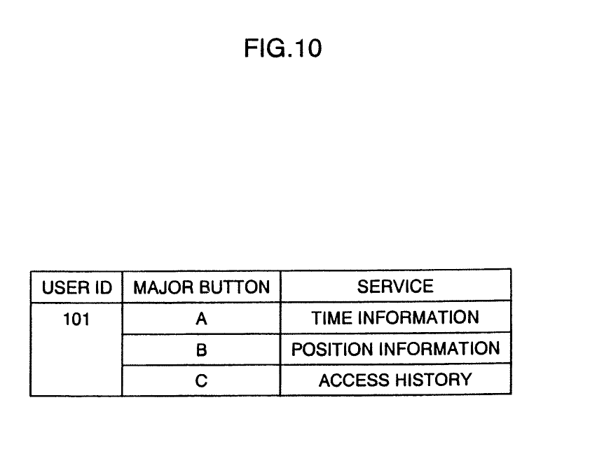

The service assignment information includes information about which services are assigned to the “major button A” 23d, the “major button B” 23e, and the “major button C” 23f for each client portable terminal. The service assignment information includes, for example as illustrated in FIG. 10, user IDs, major buttons (major buttons A, B and C), and assigned services in association with one another. The registration and updating of the service assignment information will be described later in detail.

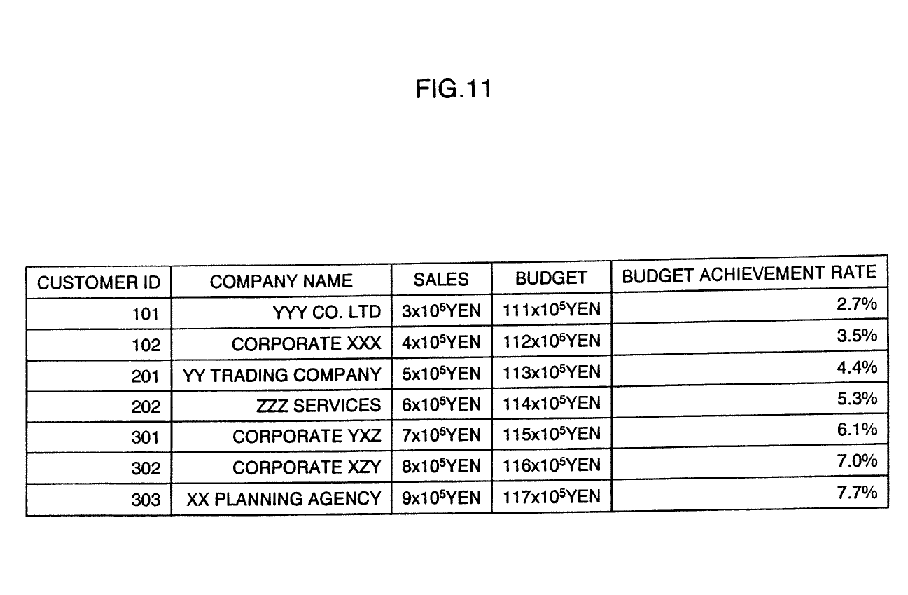

The sales by customer information includes information about sales, budgets, and budget achievement rate for each customer. The sales by customer information includes, for example as illustrated in FIG. 11, customer IDs, company names, sales, budgets, and budget achievement rates, in association with one another. The sales by customer information is regularly updated (for example, once a day) via the client PC 30, etc. Note that although, in FIG. 11, customer IDs and company names are stored, customer IDs alone are sufficient and the company name is not a necessity.

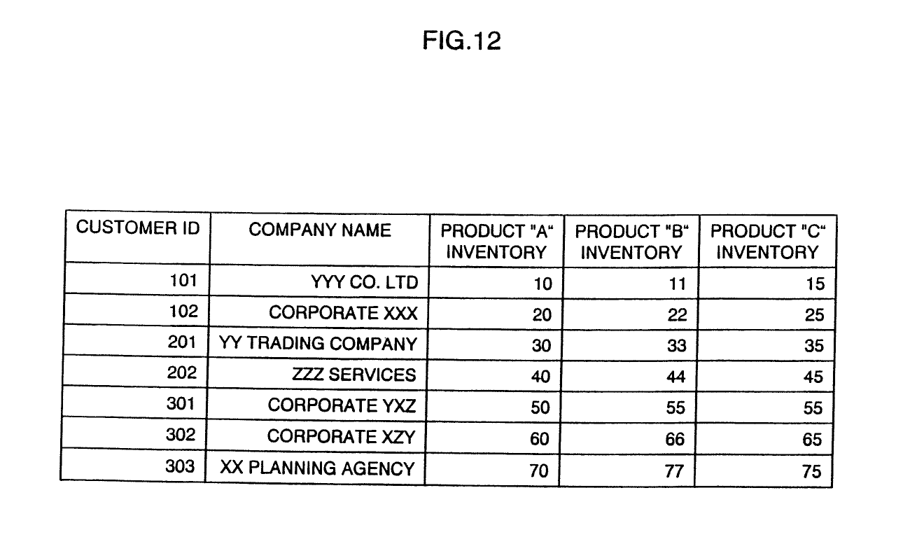

The inventory by customer information includes information about inventories of each product for each customer. The inventory by customer information includes, for example as illustrated in FIG. 12, customer IDs, company names, inventories of product A, inventories of product B, and inventories of product C in association with one another. Note that although, in FIG. 12, customer IDs and company names are stored, customer IDs alone are sufficient and the company name is not a necessity. The inventory by customer information is regularly updated (for example, every time order is made from a customer). The inventory by customer information may be updated via the client PC 30, or may be automatically updated by an order system (not illustrated) connected with the business support apparatus 10 via a network every time an order is inputted.

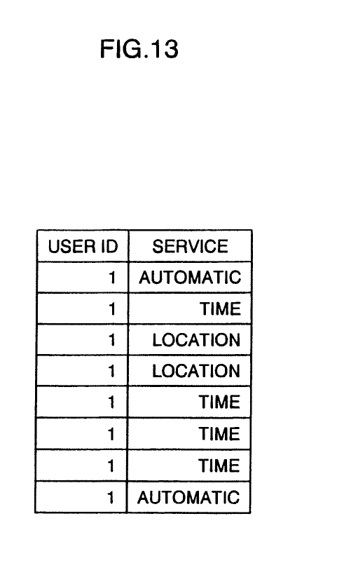

The provided service history information includes information about services, which have been provided, for each user. The provided service history information includes, for example as illustrated in FIG. 13, user IDs and services provided by the business support apparatus 10 in association with each other. The registration and updating of the provided service history information will be described later in detail.

Moreover, the storage device 11d includes information which is required by the “business support service A” 12, the “business support service B” 13, the “business support service C” 14, the “business support service D” 15, and the “business support service E” 16 to generate pages; for example, budgets and budget achievement rates, order information, delivery status, and sales, etc. for each user.

The “business support service A” 12, the “business support service B” 13, the “business support service C” 14, the “business support service D” 15, and the “business support service E” 16 respectively include a control part and a storage part in which a business support program for generating pages relating to the business support services is stored in a dedicated storage area.

The “business support service A” 12 is configured such that a business support program “a” is stored in a storage part, and a control part integrally controls the “business support service A” 12 according to the business support program “a” to acquire necessary data from the storage device 11d in response to the instruction from the function determination device 11b, and to generate a page in which a list of schedules of user are described (hereafter, referred to as a schedule page).

The “business support service B” 13 is configured such that a business support program “b” is stored in a storage part and a control part integrally controls the “business support service B” 13 according to the business support program “b” to acquire necessary data from the storage device 11d in response to the instruction from the function determination device 11b, and to generate a page by which a user can produce daily reports (hereafter, referred to as a daily report page).

The “business support service C” 14 is configured such that a business support program “c” is stored in a storage part and a control part integrally controls the “business support service C” 14 according to the business support program “c” to acquire necessary data from the storage device 11d in response to the instruction from the function determination device 11b, and to generate a page in which addresses and telephone numbers of customers, etc. are described (hereafter, referred to as a general information page).

The “business support service D” 15 is configured such that the business support program “d” is stored in a storage part and a control part integrally controls the “business support service D” 15 according to the business support program “d” to acquire necessary data from the storage device 11d in response to the instruction from the function determination device 11b, and to generate a page in which budgets, monthly sales, and budget achievement rates for each customer, etc. are described (hereafter referred to as a sales information page).

The “business support service E” 16 is configured such that the business support program “e” is stored in a storage part and a control part integrally controls the “business support service E” 16 according to the business support program “e” to acquire necessary data from the storage device 11d in response to the instruction from the function determination device 11b, and to generate a page in which list of inventories by customers are described (hereafter referred to as an inventory information page).

Actions of the business support system 1 which is configured as described above will be described.

Upon receiving provision of a service, the client portable terminal 20 registers the assignments of the “major button A” 23d, the “major button B” 23e, and the “major button C” 23f as initial settings. This process is enabled by a user activating the client portable terminal 20 and by a control unit 20a activating a client program. When the assignment of major buttons is performed at the client portable terminal 20, the control unit 20a transmits the result of the assignment to the business support apparatus 10 via the communication unit 20e.

The communication device 11a of the business support apparatus 10 receives and outputs the result of the assignment to the function determination device 11b. The function determination device 11b judges that the received information relates to the result of the assignment to the major button, and stores the received information in the storage device 11d. As a result of this, the service assignment information is stored in the storage device 11d. Note that this process is performed not only when initialization is performed (at the time of registration) but also when the user changes, at some midpoint, the assignment of major buttons (at the time of change). Further, this process is not limited to being performed from client portable terminal 20, but also can be performed from the client PC 30.

Hereafter, description will be made on a case in which a user having a user ID of “1” has a client portable terminal 20; as shown in FIG. 10, a service to generate a page based on time information is assigned to the “major button A” 23d; a service to generate a page based on position information of the client portable terminal 20 is assigned to the “major button B” 23e; and a service to generate a page based on access history is assigned to the “major button C” 23f.

When a user activates the client portable terminal 20, the control unit 20a activates a client program stored in the storage unit 20b.

When a user presses down any of the “major button A” 23d, the “major button B” 23e, and the “major button C” 23f, an input acceptance unit 20c accepts the pressing down of the pressed major button and outputs information indicating which major button is pressed down (hereafter, referred to as key information) to the communication unit 20e. The communication unit 20e outputs the key information to the communication device 11a of the business support apparatus 10.

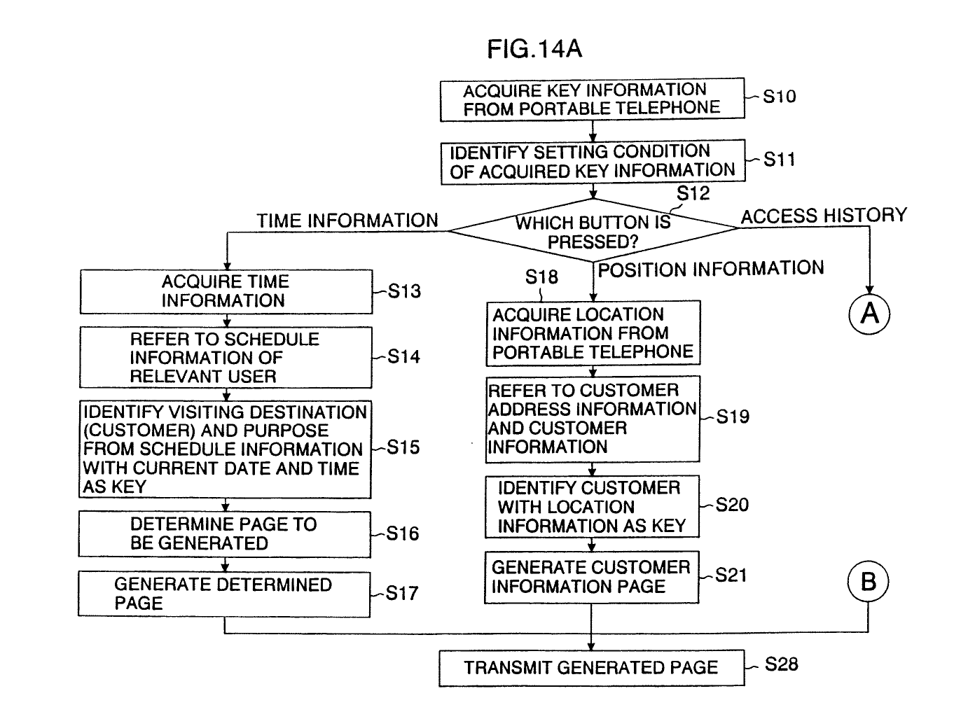

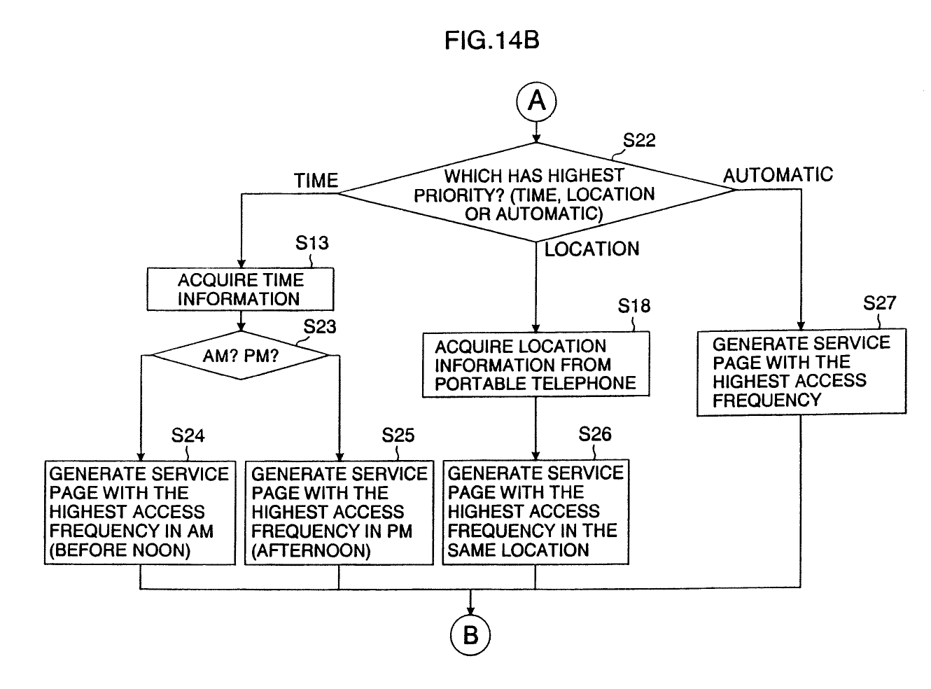

FIGS. 14A and 14B are flowcharts illustrating the flow of process of the business support apparatus 10.

The communication device 11a receives key information outputted from the communication unit 20e, and outputs the key information to the function determination device 11b (step S10).

When the key information is received by the communication device 11a, the function determination device 11b accesses the storage device 11d via the data access device 11c to acquire service assignment information (see FIG. 10) (step S11). Then, the function determination device 11b determines which service is to be performed based on the key information and the service assignment information (step S12).

When, as the key information, information indicating that the “major button A” 23d is pressed down is received, the function determination device 11b judges that a service to generate a page based on time information is to be performed, and acquires current time information from an internal clock not shown (step S13).

The function determination device 11b accesses the storage device 11d via the data access device 11c to acquire schedule information (see FIG. 6) (step S14), and identifies a visiting destination and visiting purpose based on the time information and the schedule information (step S15).

Then, the function determination device 11b accesses the storage device 11d via the data access device 11c to acquire service information (see FIGS. 8 and 9), and determines that a page in accordance with the identified visiting destination and the visiting purposes is the page to be generated (step S16).

The function determination device 11b issues an instruction to the relevant business support service based on the determination at step S16. The business support service which has received the instruction acquires necessary data from the storage device 11d to generate a required page (step S17). Hereafter, examples of the process carried out at steps S16 and S17 will be described.

For example, when the current time is 10 o'clock of Jul. 14, 2008, it is identified from the schedule information of FIG. 6 that the imminent visiting destination of user ID “1” is a customer ID “102” and the visiting purpose is “estimation”. As illustrated in FIG. 9, when the visiting purpose is “estimation”, the service ID is “3-102”. And, as illustrated in FIG. 8, the service ID “3-102” is “sales information.” Therefore, the function determination device 11b makes the determination to generate a sales information page about the customer ID “102” and issues an instruction to the “business support service D” 15.

The “business support service D” 15 acquires sales by customer information (see FIG. 11) from the storage device 11d, and generates a sales information page in which budgets for customer, sales, budgets, and budget achievement rates, etc. are described.

Moreover, when the current time is 13 o'clock of Jul. 15, 2008, it is identified from the schedule information illustrated in FIG. 6 that the imminent visiting destination of the user ID “1” is the customer ID “101”, and the visiting purpose is “business negotiations.” As illustrated in FIG. 9, when the visiting purpose is “business negations”, the service ID is “3-101”. And, as illustrated in FIG. 8, the service ID “3-101” is “general information.” Therefore, the function determination device 11b makes the determination to generate a general information page about the customer ID “101” and issues an instruction to the “business support service C” 14.

The “business support service C” 14 acquires customer information (see FIG. 4) from the storage device 11d to acquire the company name, the name of contact person, the telephone number, the FAX number, and the mail address of the customer ID “101” to generate a list of those as a general information page.

Further, when the current time is 15 o'clock of Jul. 15, 2008, it is identified from the schedule information of FIG. 6 that the imminent visiting destination of the user ID “1” is the customer ID “303” and the visiting purpose is “delivery follow-up.” As illustrated in FIG. 9, when the visiting purpose is “delivery follow-up”, the service ID is “3-103”. And, as illustrated in FIG. 8, the service ID “3-103” is “inventory status”. Therefore, the function determination device 11b makes the determination to generate an inventory status and issues an instruction to the “business support service E” 16.

The “business support service E” 16 acquires the inventory by customer information (see FIG. 12) from the storage device 11d and generates an inventory information page in which a list of the inventories of customer is described.

When as the key information, information indicating that the “major button B” 23e is pressed down is received, the function determination device 11b judges that a service to generate a page based on the position information of the client portable terminal 20 is to be performed and transmits an instruction, which requires to transmit the position information of the client portable terminal 20, to the client portable terminal 20 via the communication device 11a. The control unit 20a of the client portable terminal 20 receives the instruction transmitted from the business support apparatus 10 via the communication unit 20e and issues an instruction, which requires to acquire position information, to a position information acquisition unit 20d. The position information acquisition unit 20d acquires current position information of the client portable terminal 20, and the control unit 20a transmits the acquired position information to the business support apparatus 10 via the communication unit 20e (step S18).

The function determination device 11b acquires the position information of the client portable terminal 20 via the communication device 11a and acquires customer address information and customer information from the storage device 11d via a data access device 11c (step S19).

The function determination device 11b identifies the customer, who is in the nearest position to the client portable terminal 20, based on the position information of the client portable terminal 20 and the customer address information, and judges if the customer identified based on the customer information is a customer of the user who uses the client portable terminal 20. When the identified customer is not a customer of the user who uses the client portable terminal 20, a customer who is in the next nearest position to the client portable terminal 20 is identified and it is determined if the identified customer is a customer of the user who uses the client portable terminal 20. This process is repeated until a customer of the user who uses the client portable terminal 20 is identified.

When the identified customer is a customer of the user who uses the client portable terminal 20, the function determination device 11b determines that the user who uses the client portable terminal 20 requires the information about the customer, that is, the customer is the target of page generation (step S20) and issues an instruction to the “business support service C” 14. The “business support service C” 14 acquires customer information from the storage device 11d to acquire the company name, the name of the contact person, the telephone number, the FAX number, the mail address of the customer identified at step S20 to generate a list of those as a general information page (step S21).

When as the key information, information indicating that the “major button C” 23f is pressed down is received, the function determination device 11b judges that a service to generate a page based on the access history is to be performed, and acquires the provided service history information (see FIG. 13) from the storage device 11d to judge what the service that is most often used by the user (the service with the highest priority for the user) is (step S22).

When the user most often uses a service based on the access history with time being used as the key, the function determination device 11b acquires current time information from an internal clock which is not shown (step S13).

The function determination device 11b judges whether the current time is in the morning (before noon) or the afternoon (step S23). The function determination device 11b accesses the storage device 11d via the data access device 11c to acquire access history information (see FIG. 7) and service information (see FIG. 8). When it is determined that the current time is in the morning at step S23, the function determination device 11b generates a page corresponding to the service ID which is most often used in the morning by the user who uses client portable terminal 20 (step S24). When it is determined that the current time is in the afternoon at step S23, the function determination device 11b generates a page corresponding to the service ID which is most often used in the afternoon by the user who uses client portable terminal 20 (step S25). Hereafter, examples of the processes performed at steps S24 and S25 will be described.

For example, the service which is most often used in the morning by the user of user ID “1” is a service ID “1” in FIG. 7. In FIG. 8, the service ID “1” is “schedule”. Therefore, the function determination device 11b makes the determination to generate a schedule page of the user ID “1”, and issues an instruction to the “business support service A” 12.

The “business support service A” 12 acquires schedule information from the storage device 11d and extracts the schedule of the user ID “1” from the acquired schedule information to generate a list of extracted schedules as a schedule page.

The service which is most often used in the afternoon by the user of user ID “1” is a service ID “2” in FIG. 7. In FIG. 8, the service ID “2” is “daily reports.” Therefore, the function determination device 11b makes the determination to generate a daily report page of the user ID “1”, and issues an instruction to the “business support service B” 13. The “business support service B” 13 generates a daily report page of the user ID “1”.

When the user most often uses a service based on access history with location being as the key, the function determination device 11b transmits an instruction, which requires sending the position information of the client portable terminal 20, to the client portable terminal 20 via the communication device 11a. The control unit 20a of the client portable terminal 20 receives the instruction transmitted from the business support apparatus 10 via the communication unit 20e and issues an instruction to acquire position information to the position information acquisition unit 20d. The position information acquisition unit 20d acquires the current position information of the client portable terminal 20, and the control unit 20a transmits the position information acquired via the communication unit 20e to the business support apparatus 10 (step S18).

The function determination device 11b accesses the storage device 11d via the data access device 11c to acquire access history information (see FIG. 7) and service information (see FIG. 8), and generates a page corresponding to the service ID which is most often used by the user who uses the client portable terminal 20 in the vicinity of the position thereof (step S26).

For example, when the current position of the client portable terminal 20 is a longitude of 35.658611 and latitude of 139.74542, the service which is most often used by the user of user ID “1” is service ID “3-102” in FIG. 7. In FIG. 8, the service ID “3-102” is “sales information.” Therefore, the function determination device 11b makes the determination to generate a sales information page; acquires customer position information (see FIG. 4) from the storage device 11d; judges that the user who uses the client portable terminal 20 is requesting information about the customer ID “102” based on the customer position information and the position information of the client portable terminal 20; and issues an instruction to generate a sales information page about the customer ID “102” to the “business support service D” 15.

The “business support service D” 15 acquires sales by customer information (see FIG. 11) from the storage device 11d to generate a sales information page in which budgets for customer, sales, budgets, and budget achievement rates, etc. are described.

When the user most often uses the automatic service, the function determination device 11b accesses the storage device 11d via the data access device 11c to acquire access history information (see FIG. 7) and service information (see FIG. 8) and generates a page corresponding to the service ID which is most often used by the user who uses the client portable terminal 20 (step S27).

For example, in FIG. 7, the service which is most often used by the user of user ID “1” is a service ID “1”. In FIG. 8, the service ID “1” is “schedule”. Therefore, the function determination device 11b makes the determination to generate a schedule page of the user ID “1” and issues an instruction to the “business support service A” 12. The “business support service A” 12 acquires schedule information from the storage device 11d, and extracts the schedule of the user ID “1” from the acquired schedule information to generate a list of the extracted schedules as a schedule page.

The “business support service A” 12, “business support service B” 13, “business support service C” 14, “business support service D” 15, and “business support service E” 16 output generated pages to the communication device 11a and the communication device 11a transmits the received pages to the client portable terminal 20 (step S28).

The communication unit 20e of the client portable terminal 20 receives a page transmitted from the business support apparatus 10 and outputs it to the control unit 20a. The control unit 20a outputs the received page to a display unit 20f. As a result of this, the page transmitted from the business support apparatus 10 is displayed on the client portable terminal 20.

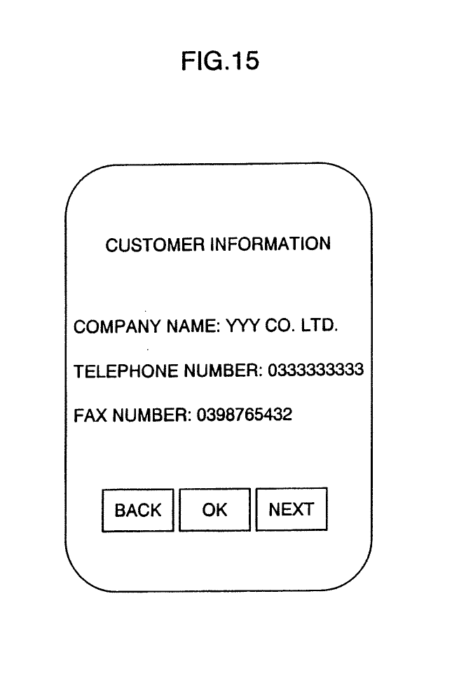

FIG. 15 illustrates an example in which a general information page is displayed on the display unit 20f. In the lower part of the page, three soft buttons: “BACK”, “OK” and “NEXT” are provided. The three soft buttons: “BACK”, “OK” and “NEXT” are selectable by a right-left button of the cross-key 23a, and it is possible to determine the selection by pressing down the middle portion of the cross-key 23a. It is also possible to select the “BACK” button by pressing down the “button B” 23c, as well as select the “NEXT” button by pressing down the “button A” 23b.

When the “OK” soft button is selected, the input acceptance unit 20c accepts and outputs the selection of the “OK” soft button to the control unit 20a, and the control unit 20a closes the page being displayed on the display unit 20f. At the same time, the input acceptance unit 20c outputs information indicating that the “OK” soft button is selected, to the communication unit 20e, and the communication unit 20e transmits the information along with the position information acquired in the position information acquisition unit 20d to the business support apparatus 10. The communication device 11a of the business support apparatus 10 receives and outputs the information and the position information to the function determination device 11b. Upon receiving the information indicating that the “OK” button is pressed down, the function determination device 11b adds to the access history, the information of the page, which is transmitted at step S28, in association with the transmitted user ID, time information, and position information. As a result of this, the access history is updated.

When the “NEXT” soft button is selected, the input acceptance unit 20c accepts and outputs the selection to the communication unit 20e, and the communication unit 20e transmits information indicating that the “NEXT” button is pressed down to the business support apparatus 10. Upon receiving the information indicating that the “NEXT” button is pressed down, the function determination device 11b issues an instruction to any of the “business support services A” 12 to “business support services E” 16 to generate a page different from the one that is transmitted at step S28.

For example, when the page transmitted at step S28 is a page generated by the service which generates a page based on time information, the function determination device 11b generates a page by a service to generate a page based on position information. When the page transmitted at step S28 is a page which is generated by the service to generate a page based on position information, the function determination device 11b generates a page by a service which generates a page based on access history.

Further, when the page transmitted at step S28 is a page generated by the service which generates a page based on access history, the function determination device 11b changes the process depending on what the highest priority service determined at step S22 is. When a page is generated based on access history with time being as the key at step S22, the function determination device 11b generates a page based on access history with location being used as the key; when a page is generated based on access history with location being as the key at step S 22, the function determination device 11b generates a page based on access history with time being as the key. When a page is generated based on automatic service at step S22, the function determination device 11b generates a page based on access history with time being used as the key. Then, a page generated in the same manner as that of step S28 is transmitted to the client portable terminal 20.

Upon receipt of information indicating that the “NEXT” button is pressed down from the client portable terminal 20, the function determination device 11b repeats the above described process. And then, upon receipt of information indicating that the “OK” button is pressed down from the client portable terminal 20, the function determination device 11b updates the access history and adds information of the page transmitted at the last time in association with the transmitted user ID to the provided service history information. As a result of this, the provided service history information is updated.

When the “BACK” soft button is selected, the input acceptance unit 20c accepts and outputs this selection to the control unit 20a, and the control unit 20a displays the page, which was displayed immediately before the page being displayed on the display unit 20f, on the display unit 20f again. In order to achieve this, the page transmitted from the business support apparatus 10 may be temporarily stored in the storage unit 20b until the “OK” soft button is selected.

According to the present embodiment, it is possible to enable a user to receive the provision of a page suitable for the user by just pressing down a major button of the client portable terminal. Therefore, a user can activate the page that the user wishes to view by one click.

Moreover, according to the present embodiment, it is possible to enlarge the application scenes and usage scenes of the ECM (enterprise content management) utilizing portable equipment.

Note that although, in the present embodiment, different services are assigned to the “major button A” 23d, the “major button B” 23e and the “major button C” 23f respectively by the user, there is no need of providing three major buttons A, B and C, and configuration may be such that one major button is provided, and the function determination device 11b automatically determines the page to be provided to the client portable terminal 20.

Further, although in the present embodiment, configuration is made such that service can be provided at the same time with the activation of the client portable terminal 20, there is no need of activating the client program all the time and the client program may be activated by the logging-in of user, etc.

The presently disclosed subject matter can be provided as a program, a computer-readable program code, a computer-readable recording medium including the computer-readable program code or a program product including the computer-readable program code to be applied to systems, without being limited to the business support system which includes the business support apparatus 10 and the client portable terminal 20.

What is claimed is:

1. A business support system comprising:
a portable terminal used by a user; and
a business support apparatus connected with the portable terminal, wherein the portable terminal comprises:
an input device;
an acceptance device for accepting an input into the input device;
a first transmission device for transmitting a signal indicating that the input is accepted, to the business support apparatus when the acceptance device accepts the input;
a first reception device for receiving a page transmitted from the business support apparatus;
a display device; and
a display control device for causing the display device to display the page received by the first reception device, and wherein
the business support apparatus comprises:
a second reception device for receiving a signal transmitted by the first transmission device;
a database for storing information about the user or information about a customer of the user;
a page generation device for generating a page suitable for the user based on the information stored in the database, upon reception of the signal from the reception device; and
a second transmission device for transmitting the page generated by the page generation device to the portable terminal.

2. The business support system according to claim 1, wherein:
the portable terminal includes a position information acquisition device for acquiring position information of the portable terminal,
the database stores position information of the customer as information about the customer of the user,
the first transmission device transmits the position information acquired by the position information acquisition device to the business support apparatus,
the second reception device acquires the position information transmitted from the first transmission device, and
the page generation device identifies a customer of a visiting destination of the user based on the position information acquired by the second reception device and the position information of the customer stored in the database, and generates a page about the identified customer.

3. The business support system according to claim 1, wherein:
the business support apparatus includes a time information acquisition device for acquiring a current time,
the database stores a schedule of the user as the information about the user, and
the page generation device generates a page in accordance with a current schedule of the user based on the current time acquired by the time information acquisition device and the schedule stored in the database.

4. The business support system according to claim 3, wherein:
the database stores a visiting time, a customer of a visiting destination, and a visiting purpose in association with each other as the schedule of the user, and
the page generation device generates a page in accordance with the customer of the visiting destination and the visiting purpose of the user.

5. The business support system according to claim 1, wherein:
the database stores a history of pages transmitted to the portable terminal, and
the page generation device generates a page based on the history stored in the database.

6. The business support system according to claim 5, wherein:
the business support apparatus includes a time information acquisition device for acquiring a current time,
the database stores a transmitted page and a transmission time in association with each other, and
the page generation device generates a page included in a category of pages which is most often transmitted in a predetermined time period including the current time based on the current time acquired by the time information acquisition device.

7. The business support system according to claim 5, wherein:
the portable terminal includes a position information acquisition device for acquiring position information of the portable terminal,
the database stores a transmitted page and a position at which the transmitted page is received by the portable terminal in association with each other,
the first transmission device transmits the position information acquired by the position information acquisition device to the business support apparatus,
the second reception device acquires the position information transmitted from the first transmission device, and
the page generation device generates a page included in a category of pages which is most often received within a predetermined range including the acquired position of the portable terminal, based on the position information of the portable terminal acquired by the second reception device.

8. The business support system according to claim 1, wherein:
the portable terminal includes a plurality of input buttons,
the acceptance device judges to which input button of the plurality of buttons an input is accepted,
the first transmission device transmits a judgment result by the acceptance device,
the database stores an assignment of service for each input button of the plurality of input buttons, and
the page generation device generates a page in accordance with the service assigned to the input button which has accepted the input based on the judgment result by the reception device and the assignment of service for each input button stored in the database.

9. A business support apparatus included in the business support system according to claim 1.
